(19) United States
(12) Patent Application Publication
(10) Pub. No.: US 2025/0316400 A1
(43) Pub. Date: Oct. 9, 2025

(54) RI MANUFACTURING APPARATUS

(71) Applicant: SUMITOMO HEAVY INDUSTRIES, LTD., Tokyo (JP)

(72) Inventor: Katsuhiko SAITO, Niihama-shi (JP)

(21) Appl. No.: 19/243,580

(22) Filed: Jun. 19, 2025

Related U.S. Application Data
(63) Continuation of application No. PCT/JP2023/046177, filed on Dec. 22, 2023.

(30) Foreign Application Priority Data
Dec. 26, 2022 (JP) 2022-208073

(51) Int. Cl. G21G 1/00; G21G 1/04

(52) U.S. Cl. CPC G21G 1/0005; G21G 1/04

(57) ABSTRACT

The present invention relates to an RI manufacturing apparatus including an accelerator, a target irradiated with a particle beam of an accelerated particle emitted from the accelerator, and an incident angle adjustment mechanism that adjusts an incident angle of the particle beam to the target. The apparatus further comprises a target attachment and detachment device attached to the accelerator.

### CROSS-REFERENCE TO RELATED APPLICATIONS

This is a bypass continuation of International PCT Application No. PCT/JP2023/046177, filed on Dec. 22, 2023, which claims priority to Japanese Patent Application No. 2022-208073, filed on Dec. 26, 2022, which are incorporated by reference herein in their entirety.

### BACKGROUND

### Technical Field

Certain embodiments of the present invention relate to an RI manufacturing apparatus.

### Description of Related Art

As an inspection method for performing a precise inspection on a brain, a heart, a cancer, or the like, a positron emission tomography (PET) has been progressively adopted. In the PET inspection, an inspection drug labeled with a radioactive isotope that emits a positron (positive electron) is introduced into a body of a subject by injection, inhalation, or the like. The inspection drug introduced into the body is metabolized or accumulated in a specific site (for example, a tumor or a lesion site). In this case, the positive electron is emitted from the radioactive isotope labeled with the inspection drug, and when the positive electron is combined with an electron in a periphery thereof and is annihilated, radiation is emitted. The radiation is detected and processed by a computer. In this manner, a captured image in a predetermined region is obtained.

As the radioactive isotope used for the inspection drug of the PET inspection, ¹⁸F, ¹⁵O, ¹¹C, ¹³N, and the like are used. Since a half-life of these radioactive isotopes is as extremely short as 2 to 110 minutes, a particle accelerator such as a cyclotron is installed in a place close to an inspection room in a hospital, and an accelerated particle from the particle accelerator is guided to a target to manufacture the radioactive isotope through a nuclear reaction with a target material. The inspection drug is manufactured through synthesizing by incorporating the manufactured radioactive isotope into a predetermined compound or by replacing a portion of the manufactured radioactive isotope.

In manufacturing this radioactive isotope, for example, as disclosed in the related art, the target is fixed to a derivation portion through which the accelerated particle of the particle accelerator is derived. In this manner, the accelerated particle enters an inside of the target through the derivation portion of the particle accelerator, and the target material is subjected to the nuclear reaction to generate the radioactive isotope.

### SUMMARY

The concept of the present invention is as follows.
(1) According to an embodiment of the present invention, there is provided an RI manufacturing apparatus including an accelerator, a target irradiated with a particle beam of an accelerated particle emitted from the accelerator, and an incident angle adjustment mechanism that adjusts an incident angle of the particle beam to the target.
(2) The RI manufacturing apparatus according to (1) may further include a target attachment and detachment device that is attached to the accelerator, that holds a plurality of the targets, and that selectively attaches and detaches any one of the plurality of targets to and from a derivation portion of the accelerated particle in the accelerator.
(3) In the RI manufacturing apparatus according to (2), the target may be attached to and detached from the derivation portion in a state of being held by the target attachment and detachment device, and the incident angle adjustment mechanism may adjust the incident angle of the particle beam to the target by adjusting a posture of the target attachment and detachment device with respect to the accelerator.
(4) In the RI manufacturing apparatus according to (2) or (3), the target attachment and detachment device may hold a plurality of types of the targets having mutually different states of a material.
(5) In the RI manufacturing apparatus according to any one of (3) and (4), the incident angle adjustment mechanism may include a plurality of joint portions for moving the target attachment and detachment device with respect to the accelerator.

### BRIEF DESCRIPTION OF THE DRAWINGS

FIG. 1 is a front view illustrating a configuration of a target attachment and detachment device according to one embodiment, which is included in an RI manufacturing apparatus.

FIG. 2 is a perspective view illustrating a configuration of a base plate.

FIG. 3 is a perspective view illustrating a configuration of a guide plate.

FIG. 4 is a bottom view illustrating a configuration of the target attachment and detachment device.

FIG. 5 is a perspective view illustrating a configuration of a slide plate.

FIG. 6 is a perspective view illustrating a state where the slide plate is fitted to the guide plate.

FIG. 7 is a section view illustrating a state where the target attachment and detachment device is fixed by a fixing tool.

FIGS. 8A and 8B are section views illustrating a state where the guide plate is displaced in an X-direction.

FIGS. 9A to 9C are front views illustrating a state where the guide plate is displaced in a Y-direction.

FIG. 10 is a section view illustrating a state where a target is mounted on a derivation portion of an accelerated particle.

FIG. 11 is a section view illustrating a state where the target is separated from the derivation portion of the accelerated particle.

FIG. 12 is a perspective view illustrating a configuration of a target attachment and detachment device according to another embodiment, which is included in the RI manufacturing apparatus.

FIG. 13 is a perspective view illustrating a configuration of a base plate.

FIG. 14 is a perspective view when a first slide plate is viewed from an upper surface.

FIG. 15 is a perspective view when the first slide plate is viewed from a lower surface.

FIG. 16 is a perspective view illustrating a configuration of a second slide plate.

FIGS. 17A and 17B are section views illustrating a state where a target is attached to and detached from the derivation portion of the accelerated particle.

FIGS. 18A and 18B are views for describing engagement between the second slide plate and a drive shaft of a third air cylinder.

FIGS. 19A and 19B are views for describing displacement of the second slide plate with respect to the first slide plate.

FIGS. 20A to 20E are schematic views for describing a state where the target is positioned in the Y-direction by second and third air cylinders.

FIG. 21 is a section view illustrating the RI manufacturing apparatus including a current detector.

FIG. 22A is a perspective view illustrating an installation form of the target with respect to the slide plate, and FIG. 22B is a perspective view illustrating an attachment state of the base plate to an attachment base.

FIG. 23A is a schematic view illustrating a state where the target is inclined with respect to an irradiation direction of a particle beam, and FIG. 23B is a schematic view illustrating a state where the target is perpendicular to the irradiation direction of the particle beam.

FIGS. 24A and 24B are views illustrating an example of a posture change mechanism that changes a posture of the target.

FIGS. 25A and 25B are views illustrating another example of the posture change mechanism that changes the posture of the target.

FIG. 26 is a perspective view illustrating another example of the target attachment and detachment device.

### DETAILED DESCRIPTION

In manufacturing this type of radioactive isotope (RI), when a new target is attached to a derivation portion of an accelerated particle, it is necessary to set the accelerator in accordance with the target, and thus, a downtime of the accelerator occurs for the setting. It is desirable to provide an RI manufacturing apparatus that reduces a downtime of an accelerator which occurs due to target replacement and that easily increases a manufacturing amount of RI.

Hereinafter, an embodiment of the present invention will be described with reference to the accompanying drawings. In the description of the drawings, the same reference numerals will be assigned to the same elements, and repeated description will be omitted.

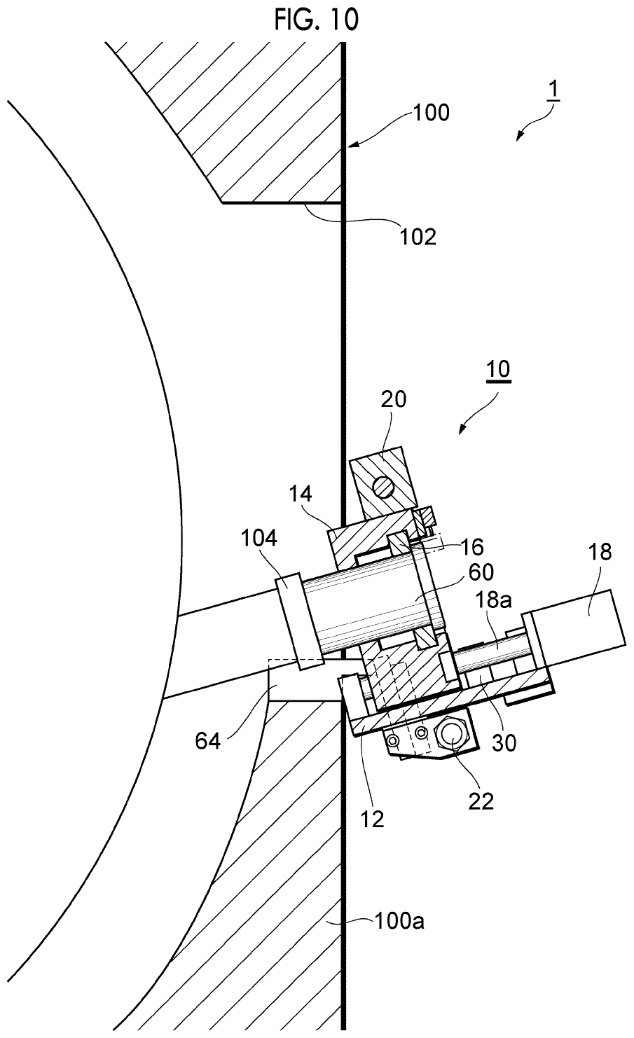

As illustrated in FIG. 10, an RI manufacturing apparatus 1 includes a cyclotron 100 (accelerator) and a target 60 attached to the cyclotron 100. The target 60 is detachably attached to a derivation portion 104 of an accelerated particle in the cyclotron 100, and the target 60 is irradiated with a particle beam (for example, a proton beam) of the accelerated particle emitted from the derivation portion 104. In this manner, the accelerated particle and a target material of the target 60 cause a nuclear reaction to generate a radioactive isotope.

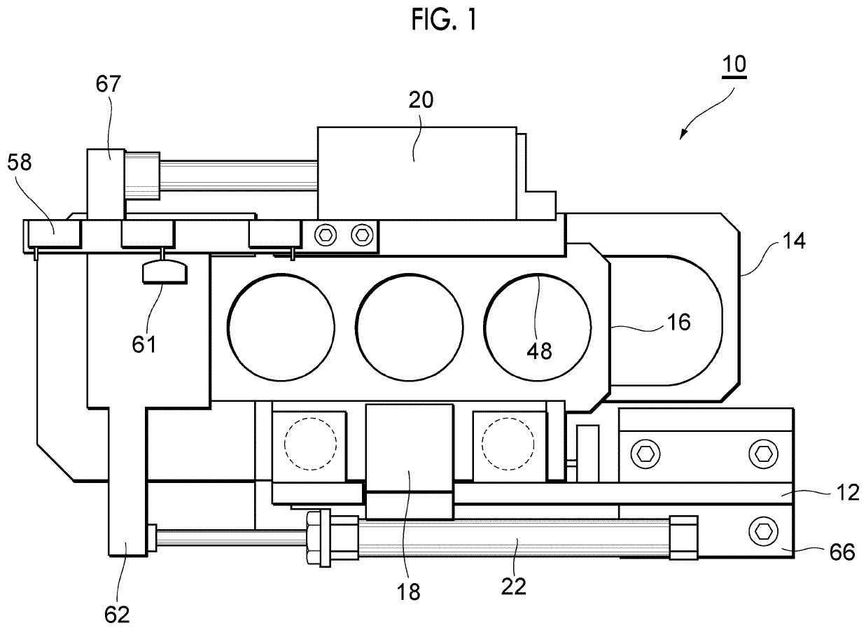

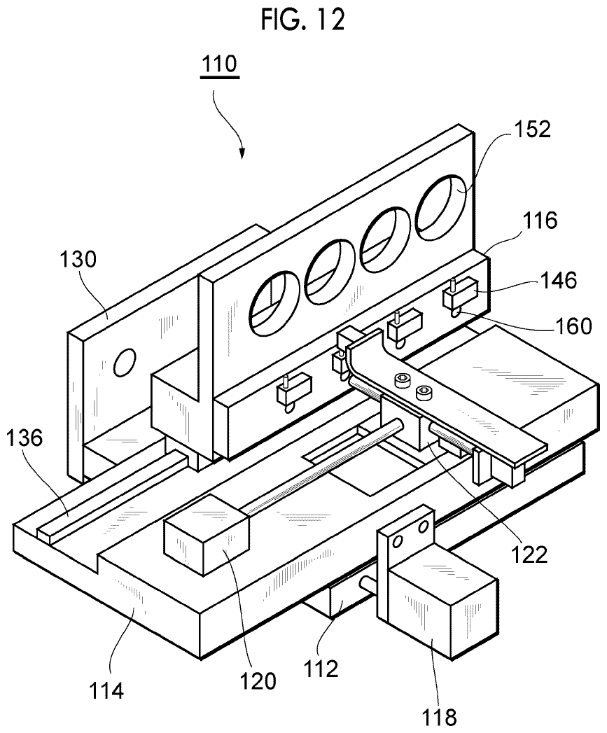

Furthermore, the RI manufacturing apparatus 1 includes a target attachment and detachment device 10. The RI manufacturing apparatus 1 may include a target attachment and detachment device 110 (FIG. 12) instead of the target attachment and detachment device 10. The target attachment and detachment devices 10 and 110 are attached to a main body part 100a of the cyclotron 100 via an attachment base 64 (fixing tool). More specifically, a base end portion of the attachment base 64 is fixed to an opening portion 102 of a fixed yoke of an electromagnet of the cyclotron 100 in the main body part 100a of the cyclotron 100. The target attachment and detachment devices 10 and 110 are attached to a tip portion of the attachment base 64. In this manner, the target attachment and detachment devices 10 and 110 are cantilevered in the main body part 110a via the attachment base 64. The target attachment and detachment device 10 and 110 have a function of holding a plurality of the targets 60 and selectively attaching and detaching the held target 60 to and from the derivation portion 104. As an example of the target attachment and detachment device included in the RI manufacturing apparatus 1, the target attachment and detachment device 10 (FIG. 1) according to a first embodiment and the target attachment and detachment device 110 (FIG. 12) according to a second embodiment will be described below.

### First Embodiment

FIG. 1 is a front view illustrating a configuration of the target attachment and detachment device according to the first embodiment. As illustrated in FIG. 1, the target attachment and detachment device 10 includes a base plate 12, a guide plate 14, a slide plate 16, a first air cylinder 18, a second air cylinder 20, and a third air cylinder 22.

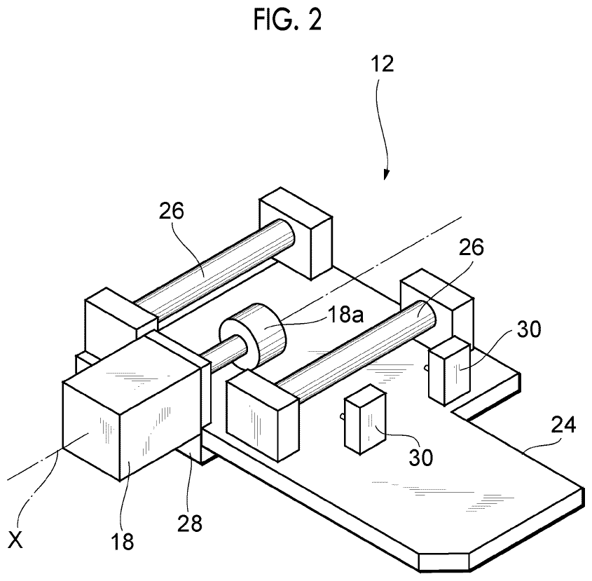

As illustrated in FIG. 2, the base plate 12 has a rectangular outer shape, and one corner portion is cut out to form an attachment portion 24 for attaching the target attachment and detachment device 10 to the cyclotron 100. A pair of guide rods 26 are provided in parallel in a short direction on an upper surface of the base plate 12. Between the pair of guide rods 26, the first air cylinder (second drive unit) 18 is attached to a front side surface of the base plate 12 via a substantially L-shaped bracket 28. A drive shaft 18a of the first air cylinder 18 is movable forward and rearward in an extending direction of the guide rod 26. A forward and rearward movement direction of the drive shaft 18a of the first air cylinder 18 will be defined as an X-direction (second direction) for convenience. In addition, a pair of microswitches 30 are provided at a predetermined interval on an upper surface of the base plate 12 in the X-direction. The microswitch 30 is used to detect a position of the guide plate 14 in the X-direction (to be described later).

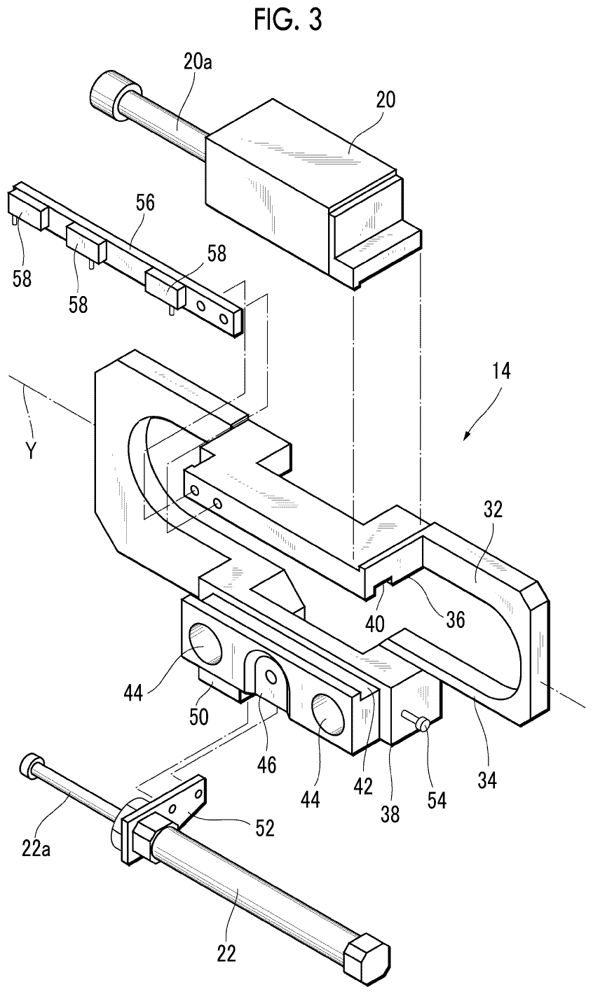

As illustrated in FIG. 3, the guide plate 14 is an annular member having an elliptical opening portion, and includes upper and lower frame bodies 32 and 34 extending in a major axis direction of the opening portion, and left and right frame bodies extending in a minor axis direction. The major axis direction of the opening portion of the guide plate 14 will be defined as the Y-direction for convenience (first direction). Protrusion portions 36 and 38 protruding forward are provided in respective central portions of the upper and lower frame bodies 32 and 34. A guide groove 40 extending in the Y-direction is provided on a lower surface of the protrusion portion 36 of the upper frame body 32. In addition, a guide groove 42 extending in the Y-direction is provided on an upper surface of the protrusion portion 38 of the lower frame body 34 to correspond to the guide groove 40 of the upper frame body 32. The slide plate 16 (to be described later) is fitted into the pair of guide grooves 40 and 42, and slides in the Y-direction.

The protrusion portion 38 of the lower frame body 34 is provided with a pair of through-holes 44 that penetrate a front surface and a rear surface. An interval between the pair of through-holes 44 is equal to an interval between the pair of guide rods 26 on the base plate 12. In addition, a recessed portion 46 for connecting a tip portion of the drive shaft 18a of the first air cylinder 18 is provided on a front surface of the protrusion portion 38 of the lower frame body 34 between the pair of through-holes 44.

The second air cylinder (first drive unit, linear drive mechanism) 20 is provided on an upper surface of the guide plate 14. A drive shaft 20a of the second air cylinder 20 is movable forward and rearward in the Y-direction. A stroke of the second air cylinder 20 is the same as a pitch of the holding portion 48 of the slide plate 16 (to be described later), and is 70 mm, for example.

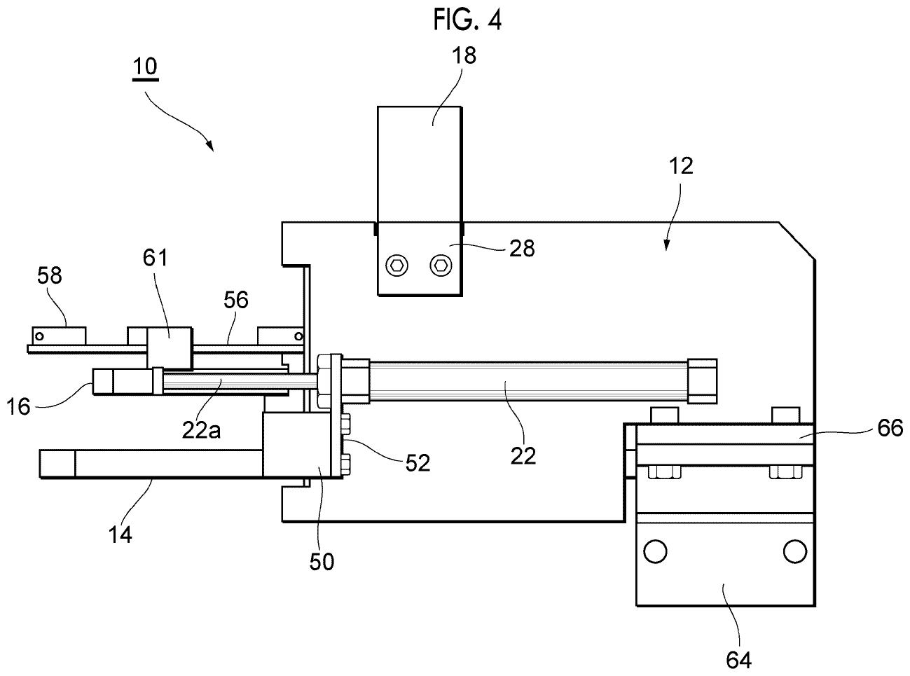

As illustrated in FIGS. 3 and 4, a substantially L-shaped bracket 50 is provided on the lower surface of the guide plate 14, and the third air cylinder (first drive unit, linear drive mechanism) 22 is provided in the bracket 50 via an attachment plate 52. A drive shaft 22a of the third air cylinder 22 is movable forward and rearward in the Y-direction. The drive shaft 20a of the second air cylinder 20 and the drive shaft 22a of the third air cylinder 22 move forward and rearward in the same direction. The stroke of the third air cylinder 22 is the same as the length of twice the pitch of the holding portion 48 of the slide plate 16 (to be described later), and is 140 mm, for example.

A detection pin 54 protrudes on a right side surface of the protrusion portion 38 of the lower frame body 34 of the guide plate 14. The detection pin 54 comes into contact with the microswitch 30 on the base plate 12, thereby detecting a position of the guide plate 14 in the X-direction.

A sensor attachment plate 56 extending in the Y-direction is attached to a front surface of the upper frame body 32 of the guide plate 14. Three microswitches 58 are provided at a predetermined interval on a front surface of the sensor attachment plate 56.

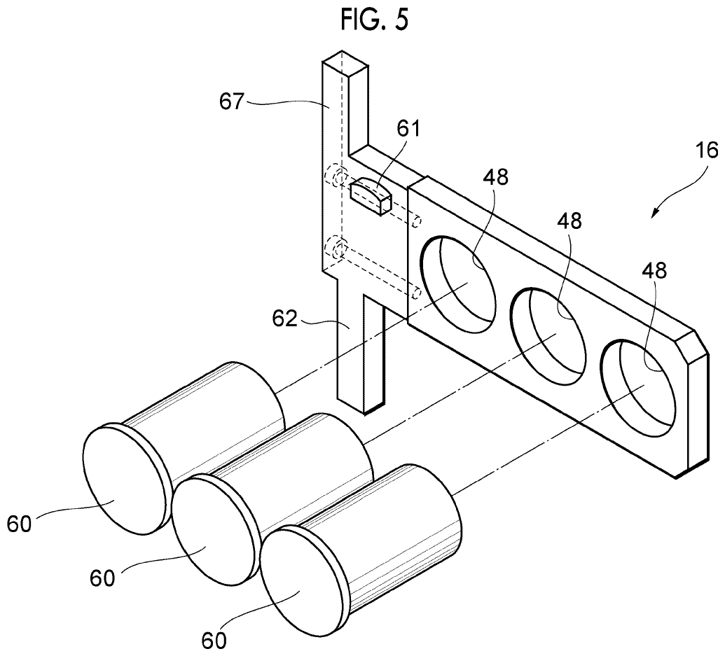

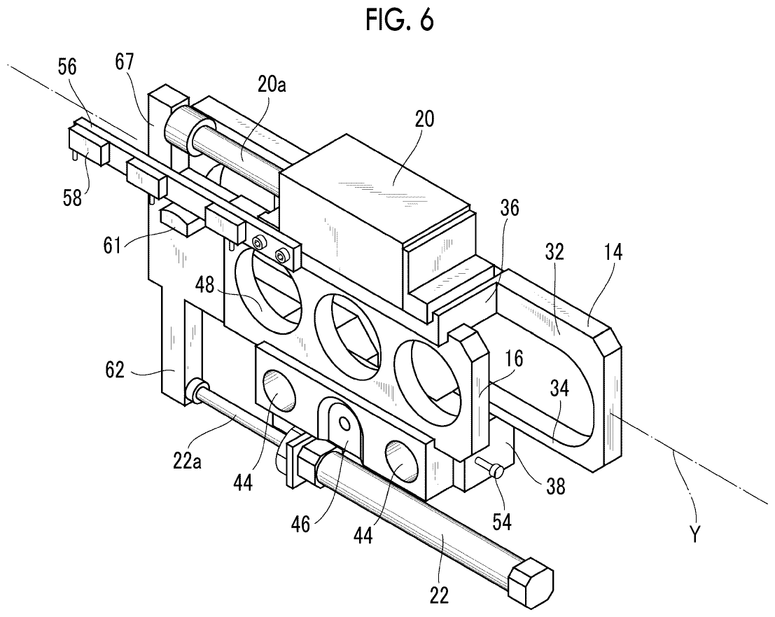

The slide plate (target holding member) 16 has a rectangular shape in a front view as illustrated in FIG. 5. The slide plate 16 includes three circular holes (holding portions) 48 for holding the target 60, and the target 60 having a substantially cylindrical shape is fitted into and held by each of the circular holes 48. The three circular holes 48 are aligned in a predetermined direction, and as illustrated in FIG. 6, when the slide plate 16 is fitted to the guide grooves 40 and 42 of the guide plate 14, an alignment direction thereof extends along the Y-direction.

An upper contact piece 67 extending upward and a lower contact piece 62 extending downward are provided in a left side edge portion of the slide plate 16. As illustrated in FIG. 6, when the slide plate 16 is fitted into the guide grooves 40 and 42 of the guide plate 14, a tip of the third air cylinder 22 is connected and fixed to a side surface of the lower contact piece 62. In addition, a tip of the second air cylinder 20 can come into contact with a side surface of the upper contact piece 67. The upper contact piece 67 and the tip portion of the second air cylinder 20 are not connected and fixed to each other.

An attacker 61 is provided on a left front surface of the slide plate 16. As illustrated in FIG. 6, since the attacker 61 comes into contact with the microswitch 58 of the sensor attachment plate 56, the position of the slide plate 16 in the Y-direction is detected.

As illustrated in FIG. 6, the slide plate 16 is fitted into the guide grooves 40 and 42 provided in the protrusion portions 36 and 38 of the guide plate 14, and is slid in the Y-direction by the second and third air cylinders 20 and 22. The guide plate 14 into which the slide plate 16 is fitted is attached to the base plate 12 illustrated in FIG. 2. More specifically, the pair of guide rods 26 on the base plate 12 are inserted into the pair of through-holes 44 formed in the protrusion portion 38 of the lower frame body 34 of the guide plate 14, and the tip portion of the drive shaft 18a of the first air cylinder 18 is connected and fixed to the recessed portion 46. In this manner, the guide plate 14 is displaced in the X-direction by moving the drive shaft 18a of the first air cylinder 18 forward and rearward.

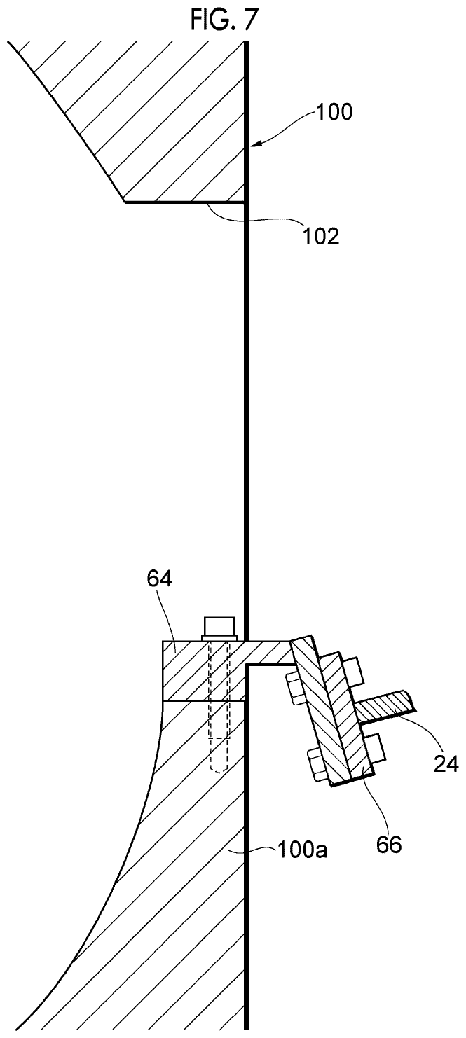

As illustrated in FIG. 7, the main body part 100a includes the attachment base 64 attached to the opening portion 102 of the fixed yoke of the electromagnet of the cyclotron 100 and an adjustment plate 66. The attachment base 64 is a member having a substantially L-shaped longitudinal section, and one side thereof is fixed to the opening portion 102 of the fixed yoke. The adjustment plate 66 is a member having a rectangular outer shape, and the attachment portion 24 of the base plate 24 is attached to be perpendicular to a surface of the adjustment plate 66. The adjustment plate 66 is screwed to the other side of the attachment base 64. In this manner, the target attachment and detachment device 10 is attached to the opening portion 102 of the fixed yoke.

Next, operations and effects of the target attachment and detachment device 10 according to the first embodiment will be described.

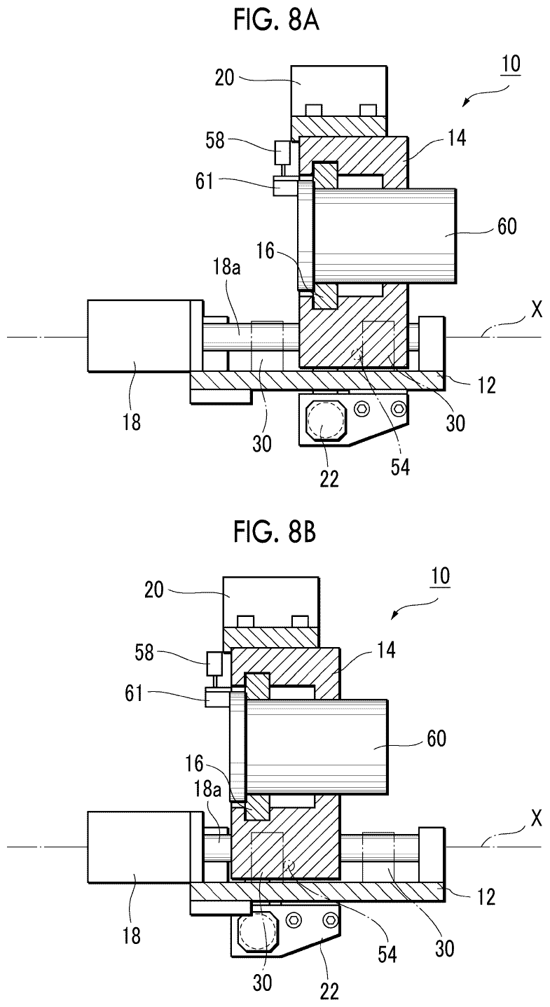

As illustrated in FIGS. 8A and 8B, the guide plate 14 into which the slide plate 16 holding the target 60 is fitted is displaced and positioned in the X-direction in such a manner that the drive shaft 18a of the first air cylinder 18 moves forward and rearward. In this case, a position of the guide plate 14 in the X-direction is detected in such a manner that the detection pin 54 comes into contact with the microswitch 30 provided on the base plate 12.

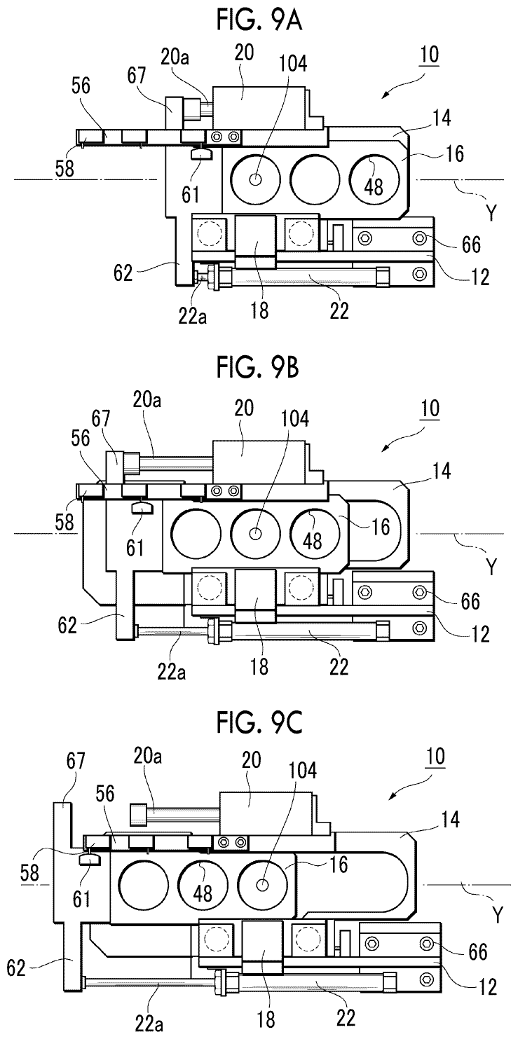

In addition, as illustrated in FIGS. 9A to 9C, the slide plate 16 holding the target 60 is displaced and positioned in the Y-direction in such a manner that the drive shafts 20a and 22a of the second and third air cylinders 20 and 22 move forward and rearward.

When the left target 60 is mounted on the derivation portion 104 of the accelerated particle, as illustrated in FIG. 9A, the drive shafts 20a and 22a are contracted and moved rearward for both the second and third air cylinders 20 and 22. When the middle target 60 is mounted on the derivation portion 104 of the accelerated particle, as illustrated in FIG. 9B, the drive shaft 20a of the second air cylinder 20 is extended to a maximum stroke, and the drive shaft 22a of the third air cylinder 22 is also extended. In addition, the positioning of the slide plate 16 in the Y-direction at this time is performed by exclusively using the maximum stroke of the second air cylinder 20. When the right target 60 is mounted on the derivation portion 104 of the accelerated particle, as illustrated in FIG. 9C, the drive shafts 20a and 22a are extended for both of the second and third air cylinders 20 and 22. In addition, the positioning of the slide plate 16 in the Y-direction at this time is performed by exclusively using the maximum stroke of the third air cylinder 22.

As illustrated in FIG. 9C, when the middle target 60 is mounted on the derivation portion 104 of the accelerated particle from a state where the right target 60 is mounted on the derivation portion 104 of the accelerated particle, the drive shaft 22a of the third air cylinder 22 is contracted and moved rearward. In this manner, as illustrated in FIG. 9B, the upper contact piece 67 of the slide plate 16 comes into contact with the tip portion of the drive shaft 20a of the second air cylinder 20, and the slide plate 16 is positioned. When the left target 60 is mounted on the derivation portion 104 of the accelerated particle, as illustrated in FIG. 9A, the drive shafts 20a and 22a are contracted and moved rearward for both the second and third air cylinders 20 and 22. As illustrated in FIGS. 9A to 9C, a position of the slide plate 16 in the Y-direction is detected in such a manner that the attacker 61 comes into contact with the microswitch 58 provided in the sensor attachment plate 56 of the guide plate 14.

FIG. 10 is a section view illustrating a state where the target 60 is mounted on the derivation portion 104 of the accelerated particles of the cyclotron 100. In this state, the target 60 is mounted on the derivation portion 104 in such a manner that the guide plate 14 into which the slide plate 16 is fitted is pressed against the drive shaft 18a of the first air cylinder 18. In this state, the accelerated particle such as a proton or a deuteron is introduced into the target 60 from the derivation portion 104. In this manner, the accelerated particle and the target material cause a nuclear reaction to generate a radioactive isotope.

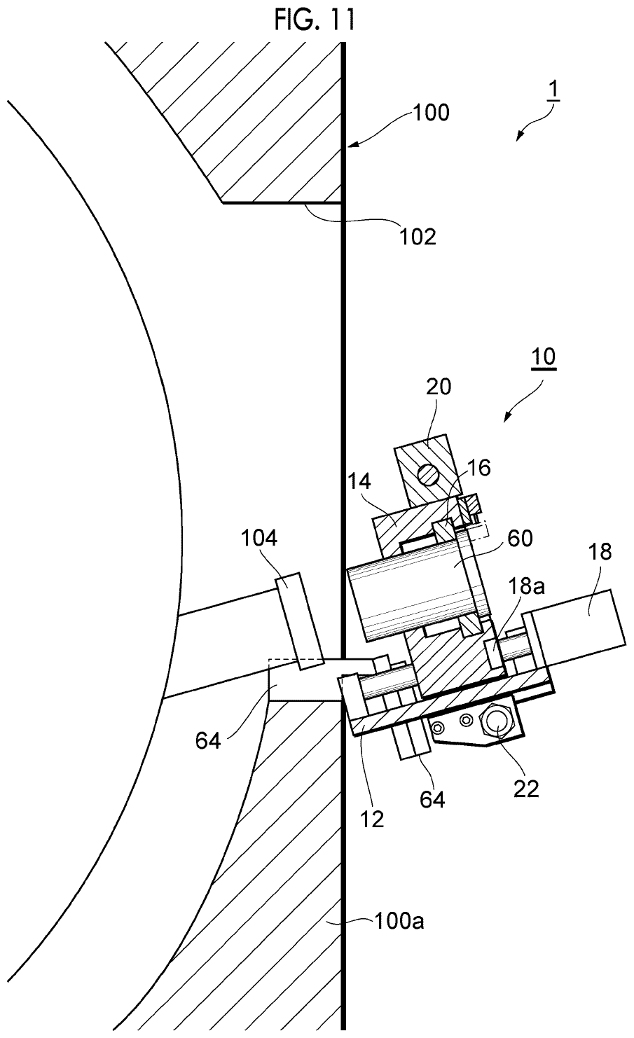

When the target 60 is replaced, as illustrated in FIG. 11, the drive shaft 18a of the first air cylinder 18 is contracted and moved rearward, and mounting of the target 60 on the derivation portion 104 is released. As illustrated in FIGS. 9A to 9C, after the desired target 60 is disposed in front of the derivation portion 104, the drive shaft 18a of the first air cylinder 18 is extended. In this manner, a new target 60 is mounted on the derivation portion 104.

In this way, in the target attachment and detachment device 10 according to the present embodiment, the target 60 is automatically replaced by a driving forces of the first to third air cylinders 18, 20, and 22. In this manner, efficiency in replacing the target is improved. In this case, a configuration is adopted as follows. The circular holes 48 for holding the target 60 are aligned in the Y-direction, and the slide plate 16 is displaced in the Y-direction by the second and third air cylinders 20 and 22. In addition, the guide plate 14 is displaced in the X-direction perpendicular to the Y-direction by the first air cylinder 18. Therefore, the plurality of targets 60 can be replaced by using a compact configuration. It is conceivable to use a method in which the target is replaced in such a manner that the plurality of targets are held and rotated by a plurality of circular holes provided in a circumferential direction of a disk. However, when the target is replaced by using this rotation, as the number of the targets increases, a radius of the disk increases, thereby causing a possibility that a size of the device significantly increases. In contrast, as in the target attachment and detachment device 10 according to the present embodiment, when the target 60 is replaced by using slide of the slide plate 16 in a linear direction, the device can have a compact size without increasing the size of the device as in the target replacement using the rotation type.

In addition, the target attachment and detachment device 10 according to the present embodiment includes the second and third air cylinders 20 and 22 having different strokes to displace the slide plate 16 in the Y-direction. Therefore, the three targets 60 held by the three circular holes 48 can be accurately positioned and displaced in the Y-direction by using a stroke difference between the second and third air cylinders 20 and 22.

### Second Embodiment

Next, the second embodiment of the present invention will be described. The same reference numerals will be assigned to the same elements as those of the target attachment and detachment device according to the first embodiment described above, and repeated description will be omitted.

FIG. 12 is a perspective view illustrating a configuration of the target attachment and detachment device 110 according to the second embodiment. As illustrated in FIG. 12, the target attachment and detachment device 110 includes a base plate 112, a first slide plate 114, a second slide plate 116, a first air cylinder 118, a second air cylinder 120, and a third air cylinder 122.

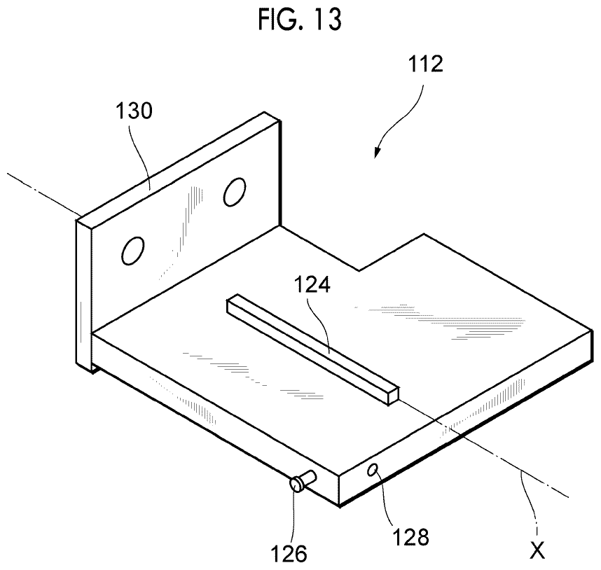

As illustrated in FIG. 13, the base plate 112 is a member that serves as a base for mounting the first and second slide plates 114 and 116. A single guide rail 124 extending in a predetermined direction is provided on an upper surface of the base plate 112. An extending direction of the guide rail 124 will be defined as the X-direction for convenience (second direction). A detection pin 126 for detecting a position of the first slide plate 114 (to be described later) in the X-direction is provided on a left side surface of the base plate 112 extending along the X-direction. A recessed portion 128 for connecting and fixing a tip portion of a drive shaft 118a of the first air cylinder 118 (to be described later) is provided on a front side surface of the base plate 112 perpendicular to the X-direction. The base plate 112 is connected to be perpendicular to a fixing plate 130 for attaching and fixing the target attachment and detachment device 110 to the cyclotron 100.

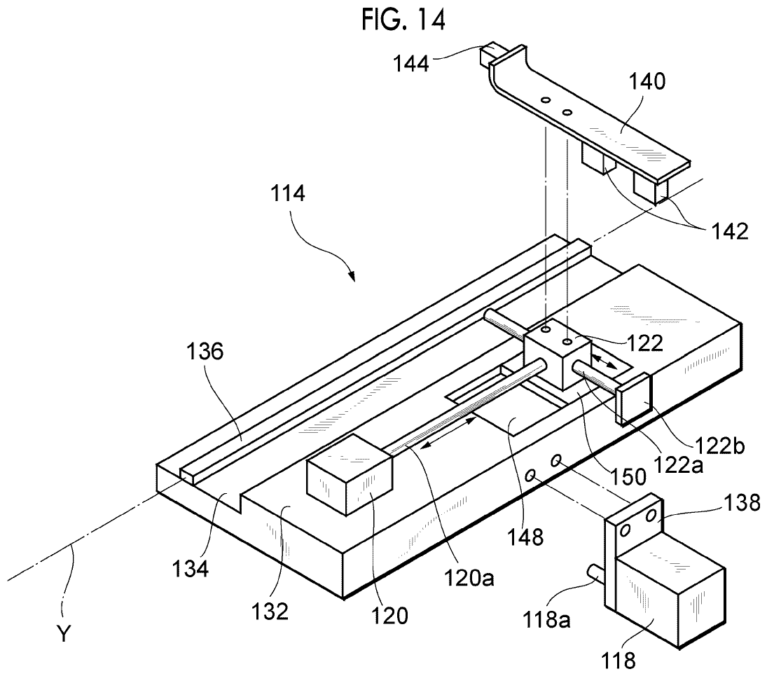

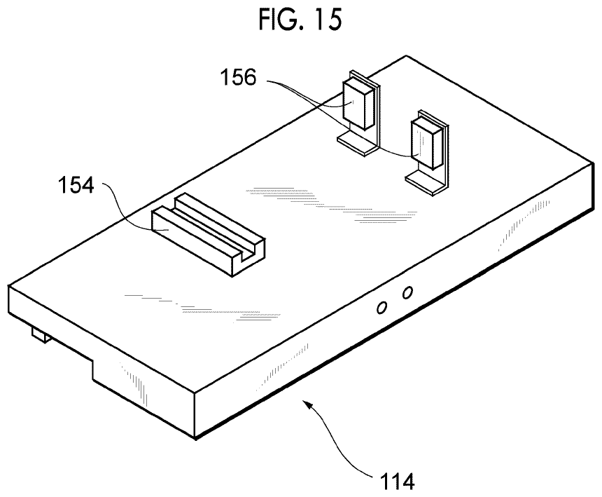

As illustrated in FIGS. 14 and 15, the first slide plate 114 is a plate-shaped member having a rectangular outer shape in a plan view. A step is provided on an upper surface of the first slide plate 114, and the first slide plate 114 is divided into an upper floor portion 132 and a lower floor portion 134 in the short direction. A guide rail 136 extending along a longitudinal direction is provided on an upper surface of the lower floor portion 134. An extending direction of the guide rail 136 will be defined as the Y-direction for convenience (first direction).

The first air cylinder (second drive unit) 118 is attached to a front side surface of the first slide plate 114 extending along the Y-direction via a bracket 138. When the first air cylinder 118 is attached to the first slide plate 114, the drive shaft 118a is located below a lower surface of the first slide plate 114, and is movable forward and rearward in a direction perpendicular to the Y-direction. The second air cylinder (first drive unit, linear drive mechanism) 120 is mounted on an upper surface of the upper floor portion 132. A drive shaft 120a of the second air cylinder 120 is movable forward and rearward in the Y-direction.

In addition, the third air cylinder (first drive unit, engagement member) 122 is mounted on the upper surface of the upper floor portion 132. The drive shaft 122a of the third air cylinder 122 is movable forward and rearward in a direction perpendicular to the Y-direction. A detection portion 122b for detecting a position of the drive shaft 122a in the direction perpendicular to the Y-direction is provided in a rear end of the drive shaft 122a of the third air cylinder 122. An attachment plate 140 extending in the direction perpendicular to the Y-direction is attached to an upper surface of the third air cylinder 122. A pair of microswitches 142 are attached to a lower surface of the attachment plate 140 at a predetermined interval. Therefore, the detection portion 122b provided in the rear end of the drive shaft 122a of the third air cylinder 122 comes into contact with any one of the pair of microswitches 142, thereby detecting the position of the drive shaft 122a in the direction perpendicular to the Y-direction.

In addition, a front end of the attachment plate 140 is bent upward. An attacker 144 is attached to this bent portion. The attacker 144 comes into contact with a microswitch 146 provided in the second slide plate 116 (to be described later). In this manner, a position of the second slide plate 116 in the Y-direction is detected.

A tip portion of the drive shaft 120a of the second air cylinder 120 is connected to and fixed to the third air cylinder 122. A recessed portion 148 having a predetermined width is provided on the upper surface of the upper floor portion 132, and a mounting plate 150 having a width half of the predetermined width is fitted into the recessed portion 148. The mounting plate 150 is slidable in the Y-direction inside the recessed portion 148, and the third air cylinder 122 is mounted on the mounting plate 150. Therefore, the third air cylinder 122 is displaced in the Y-direction with a predetermined stroke by moving the drive shaft 120a of the second air cylinder 120 forward and rearward. The predetermined stroke is set to be the same as the pitch of the circular hole 152 for attaching the target 60 of the second slide plate 116 (to be described later).

As illustrated in FIG. 15, a liner 154 having a C-shaped cross section is attached to the lower surface of the first slide plate 114. The extending direction of the liner 154 is perpendicular to the Y-direction. The liner 154 is fitted to the guide rail 124 on the base plate 112. The tip portion of the drive shaft 118a of the first air cylinder 118 is connected and fixed to the recessed portion 128 of the base plate 112. In this manner, the first slide plate 114 is slidable in the X-direction by moving the drive shaft 118a of the first air cylinder 118 forward and rearward. As illustrated in FIG. 15, a pair of microswitches 156 are attached to the lower surface of the first slide plate 114 at a predetermined interval in the direction perpendicular to the Y-direction. Therefore, when the first slide plate 114 slides in the X-direction, the detection pin 126 of the base plate 112 comes into contact with any one of the pair of microswitches 156, thereby detecting the position of the first slide plate 114 in the X-direction.

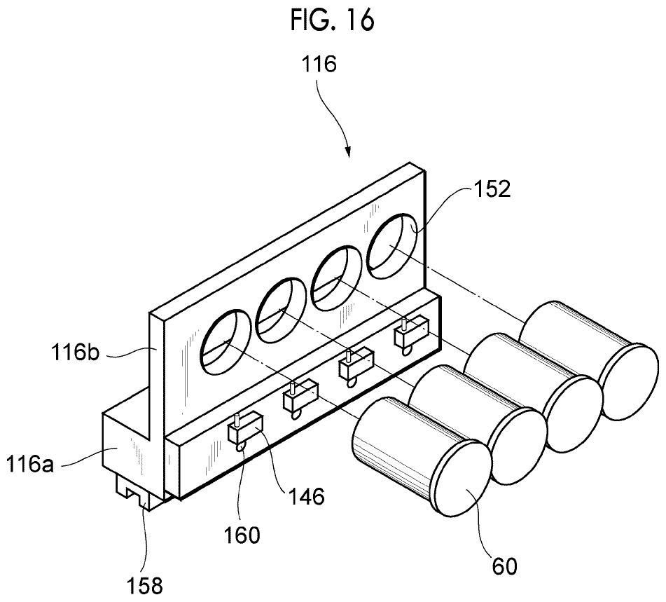

As illustrated in FIG. 16, the second slide plate (target holding member) 116 includes a rectangular parallelepiped-shaped base portion 116a and a holding plate portion 116b erected on the base portion 116a. A liner 158 having a C-shaped cross section extending in the longitudinal direction is attached to a lower surface of the base portion 116a. The holding plate portion 116b has a rectangular shape in a front view. The holding plate portion 116b has four circular holes (holding portions) 152 for holding the target 60, and the target 60 having a substantially cylindrical shape is fitted into and held by each of the circular holes 152. The four circular holes 152 are aligned along the extending direction of the liner 158, and as illustrated in FIG. 12, when the second slide plate 116 is fitted into the guide rail 136 on the first slide plate 114 via the liner 158, an alignment direction thereof extends along the Y-direction.

Four microswitches 146 are attached to a front surface of the base portion 116a of the second slide plate 116 at a pitch the same as a pitch of the circular holes 152. The attacker 144 comes into contact with the microswitch 146, thereby detecting a position of the second slide plate 116 in the Y-direction. In addition, an engagement hole 160 is provided below each of the microswitches 146. The engagement hole 160 has a size substantially the same as a diameter of the drive shaft 122a of the third air cylinder 122, and the drive shaft 122a is configured to be engageable with the engagement hole 160.

Next, operations and effects of the target attachment and detachment device 110 according to the second embodiment will be described.

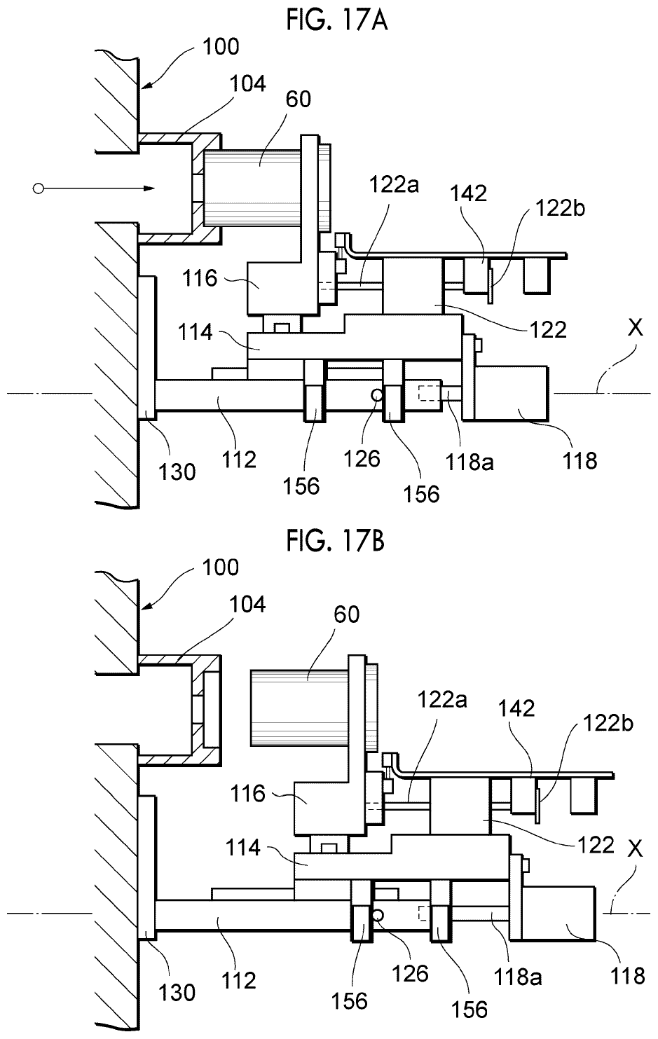

FIGS. 17A and 17B are section views illustrating a state where the target 60 is attached to and detached from the derivation portion 104 of the accelerated particle. The drive shaft 118a of the first air cylinder 118 is movable forward and rearward in the X-direction. When the drive shaft 118a of the first air cylinder 118 is contracted and moved rearward, as illustrated in FIG. 17A, the first slide plate 114 moves forward in the X-direction, and the target 60 is mounted on the derivation portion 104 of the accelerated particle of the cyclotron 100. In this case, the detection pin 126 provided on the left side surface of the base plate 112 comes into contact with the rear microswitch 156 attached to the lower surface of the first slide plate 114, thereby detecting that the first slide plate 114 is located at the position where the first slide plate 114 moves forward. That is, it is detected that the target 60 is in a state of being mounted on the derivation portion 104. In this state, the accelerated particle such as a proton or a deuteron is introduced into the target 60 from the derivation portion 104. In this manner, the accelerated particle and the target material cause a nuclear reaction to generate a radioactive isotope.

When the drive shaft 118a of the first air cylinder 118 extends, as illustrated in FIG. 17B, the first slide plate 114 moves rearward in the X-direction, and mounting between the target 60 and the derivation portion 104 is released. In this case, the detection pin 126 provided on the left side surface of the base plate 112 comes into contact with the front microswitch 156 attached to the lower surface of the first slide plate 114, thereby detecting that the first slide plate 114 is located at the position where the first slide plate 114 moves rearward. That is, it is detected that the target 60 and the derivation portion 104 are in a state where the mounting is released.

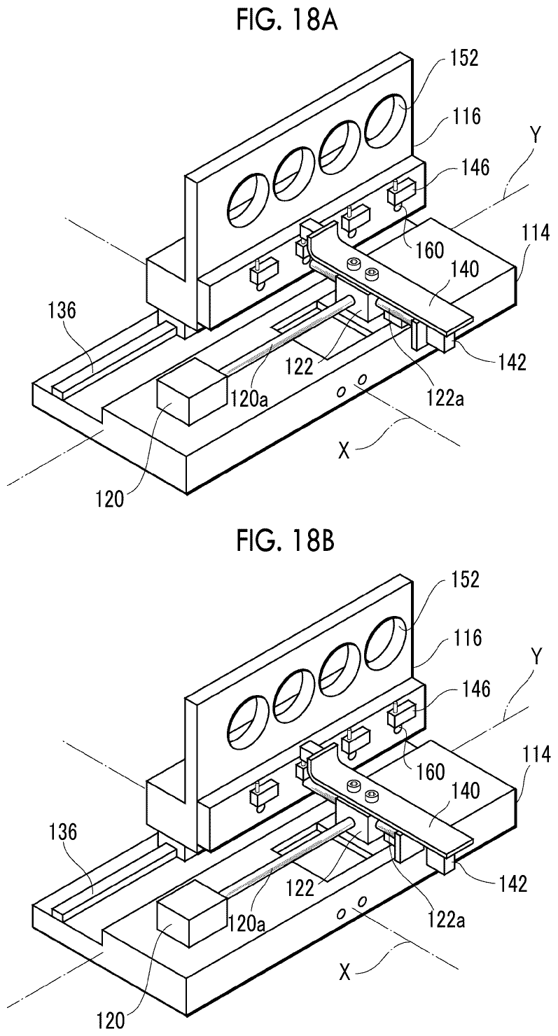

FIGS. 18A and 18B are views for describing engagement between the second slide plate 116 and the drive shaft 122a of the third air cylinder 122. The drive shaft 122a of the third air cylinder 122 is movable forward and rearward in the X-direction. When the drive shaft 122a is located at a position where the drive shaft 122a moves rearward, as illustrated in FIG. 18A, engagement between the engagement hole 160 of the second slide plate 116 and the tip portion of the drive shaft 122a is released. In this case, the detection portion 122b provided in the rear end of the drive shaft 122a comes into contact with the rear microswitch 142 attached to the attachment plate 140, thereby detecting that the engagement between the engagement hole 160 and the tip portion of the drive shaft 122a is released.

When the drive shaft 122a is located at a position where the drive shaft 122a moves forward, as illustrated in FIG. 18B, the engagement hole 160 of the second slide plate 116 and the tip portion of the drive shaft 122a engage with each other. In this case, the detection portion 122b provided in the rear end of the drive shaft 122a comes into contact with the front microswitch 142 attached to the attachment plate 140, thereby detecting that the engagement hole 160 and the tip portion of the drive shaft 122a engage with each other.

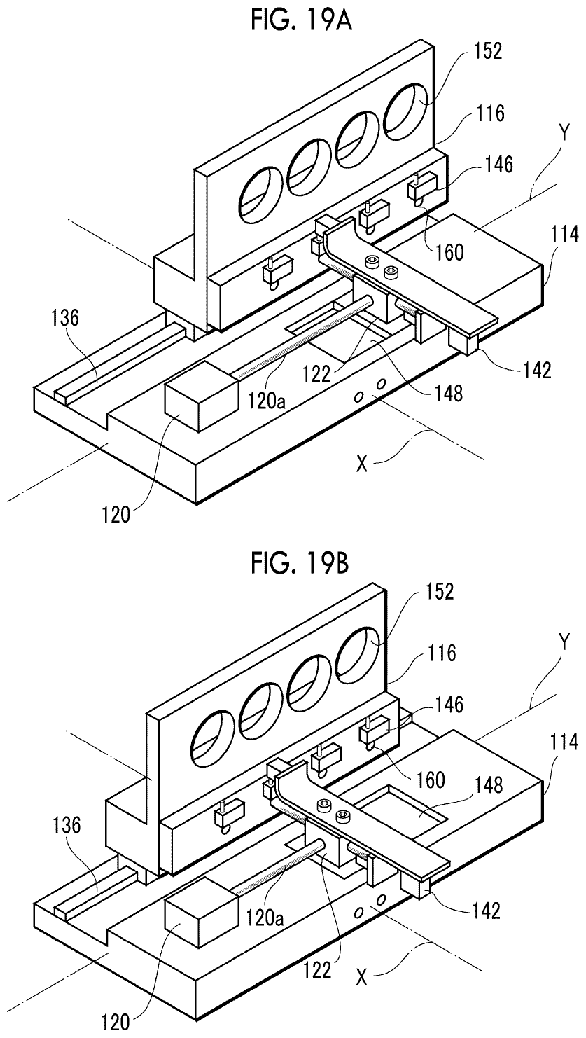

FIGS. 19A and 19B are views for describing the displacement of the second slide plate 116 with respect to the first slide plate 114. A drive shaft 120a of the second air cylinder 120 is movable forward and rearward in the Y-direction. When the drive shaft 120a extends, as illustrated in FIG. 19A, the third air cylinder 122 is pressed against the drive shaft 120a, and is located on the right side inside the recessed portion 148. When the drive shaft 120a is contracted and moved rearward, as illustrated in FIG. 19B, the third air cylinder 122 is pulled to the drive shaft 120a, and is located on the left side inside the recessed portion 148. Therefore, in a state where the drive shaft 122a of the third air cylinder 122 engages with the engagement hole 160 of the second slide plate 116, the third air cylinder 122 is displaced in the Y-direction by the second air cylinder 120. In this manner, the second slide plate 116 itself is guided by the guide rail 136, and is displaced in the Y-direction.

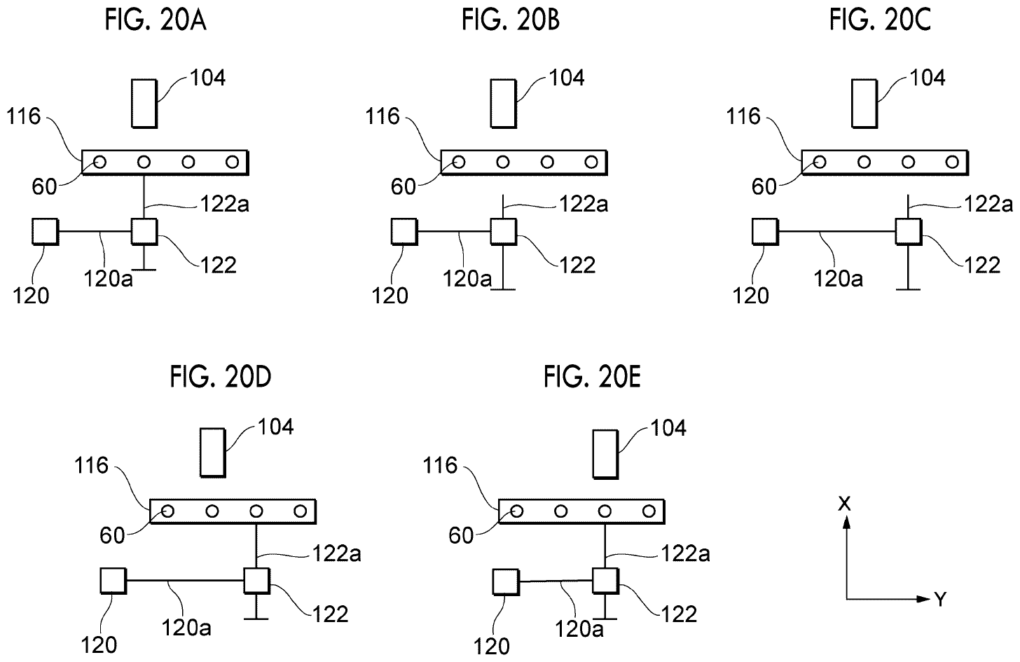

FIGS. 20A to 20E are schematic views for describing a state where the target 60 is positioned in the Y-direction by the second and third air cylinders 120 and 122. Here, a case where the second target 60 from the left is replaced with the third target 60 will be considered. In this case, the second target 60 is located in front of the derivation portion 104 as illustrated in FIGS. 20A to 20E.

First, as illustrated in FIG. 20B, the drive shaft 122a of the third air cylinder 122 is moved rearward to release the engagement between the engagement hole 160 of the second slide plate 116 and the drive shaft 122a. Next, as illustrated in FIG. 20C, the drive shaft 120a of the second air cylinder 120 is extended to displace the third air cylinder 122 in the Y-direction to be away from the second air cylinder 120. Next, as illustrated in FIG. 20D, the drive shaft 122a of the third air cylinder 122 is moved forward to engage the engagement hole 160 of the second slide plate 116 with the drive shaft 122a. As illustrated in FIG. 20E, the drive shaft 120a of the second air cylinder 120 is contracted and moved rearward to displace the third air cylinder 122 in the Y-direction to be closer to the second air cylinder 120. The other target 60 can also be positioned and displaced in the Y-direction by repeating the above-described operation.

In this way, the positioning of the target 60 in the X-direction for attaching and detaching the target 60 to and from the derivation portion 104 is performed by the first air cylinder 118, and the positioning of the target with respect to the derivation portion 104 in the Y-direction is performed by the second and third air cylinders 120 and 122 in a state where the mounting of the target 60 on the derivation portion 104 is released. In this manner, the plurality of targets 60 can be automatically and efficiently replaced.

In this way, in the target attachment and detachment device 110 according to the present embodiment, the target 60 is automatically replaced by the driving forces of the first to third air cylinders 118, 120, and 122. In this manner, efficiency in replacing the target is improved. In this case, a configuration is adopted as follows. The circular holes 152 for holding the target 60 are aligned in the Y-direction, the second slide plate 116 is displaced in the Y-direction by the second and third air cylinders 120 and 122, and the first slide plate 114 is displaced in the X-direction by the first air cylinder 118. Therefore, the plurality of targets 60 can be replaced by using a compact configuration.

In addition, the second air cylinder 120 serving as the linear drive mechanism and the third air cylinder 122 serving as the engagement member are combined with each other. In this manner, the second slide plate 116 can be accurately positioned and displaced in the Y-direction for each pitch of the circular holes 152 (pitch of the target 60). Therefore, even when the number of the targets 60 significantly increases, the targets 60 can be efficiently replaced without causing the device to be complicated.

The present invention can be modified in various ways without being limited to the above-described embodiments. For example, in the first embodiment described above, the second and third air cylinders 20 and 22 have been described as the linear drive mechanism, and in the second embodiment, the second air cylinder 120 has been described as the linear drive mechanism. However, the linear drive mechanism is not limited to the air cylinder. As the linear drive mechanism, a ball screw mechanism, a rack and pinion mechanism, or the like can also be used as long as the mechanism can be driven to linearly displace a member in a predetermined direction.

In the first embodiment, the first air cylinder 18 has been described as the second drive unit, and in the second embodiment, the first air cylinder 118 has been described as the second drive unit. However, the second drive unit is not limited to the air cylinder.

In addition, the second embodiment adopts a configuration as follows. The engagement member includes the third air cylinder 122, and the drive shaft 122a is fitted into and engaged with the engagement hole 160 provided in the second slide plate 116. However, the present invention is not limited to this configuration. The engagement member may be a member detachably engaged with the second slide plate 116 and displaceable in the Y-direction by the linear drive mechanism.

In addition, in the first embodiment, a case where the number of the targets 60 is three has been described, and in the second embodiment, a case where the number of the targets 60 is four has been described. However, the number of the targets 60 may be two, five, or more. However, in the target attachment and detachment device 10 according to the first embodiment, when the number of the targets 60 is N, the air cylinders are required as many as the N-number. In contrast, in the target attachment and detachment device 110 according to the second embodiment, the target 60 can be replaced by the three air cylinders regardless of the number of the targets 60, and a device configuration is simplified. Insulation Structure of Target

As will be described below, the RI manufacturing apparatus 1 may be provided with an insulation structure for electrically insulating the target 60 from the main body part 100a of the cyclotron 100. In the following description, an example of the insulation structure when the target attachment and detachment device 10 is adopted in the RI manufacturing apparatus 1 will be described. However, the same applies to when the target attachment and detachment device 110 is adopted. Therefore, repeated description will be omitted.

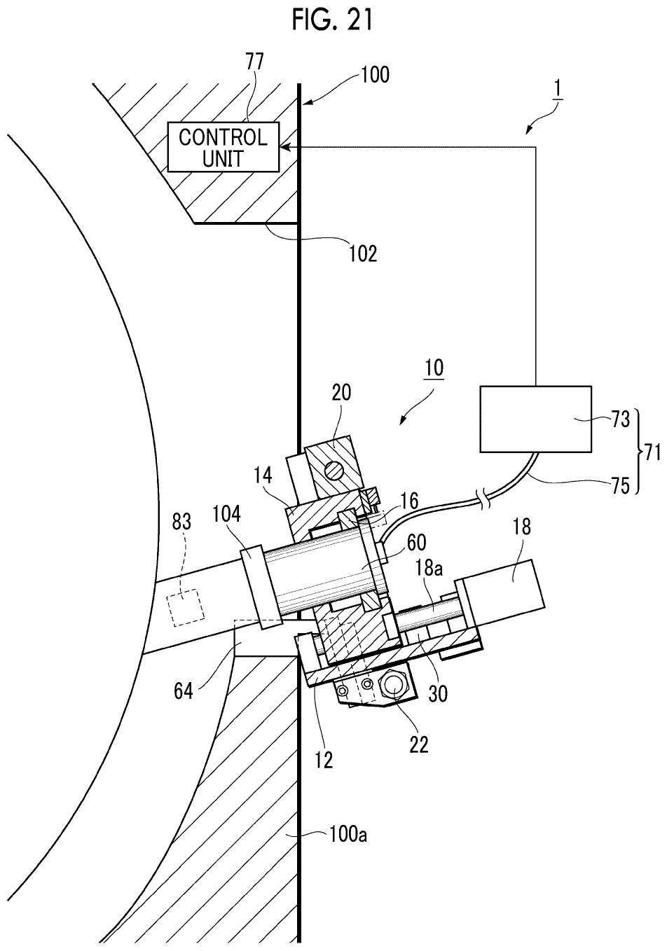

A manufacturing amount of the radioactive isotope (RI) in the RI manufacturing apparatus 1 depends on a current of the particle beam with which the target 60 is irradiated. Therefore, in the RI manufacturing apparatus 1, the current of the particle beam emitted from the derivation portion 104 of the cyclotron 100 is feedback-controlled. In this manner, the current of the particle beam with which the target 60 is irradiated is stably adjusted, and a desired manufacturing amount of the RI can be obtained with high reliability. In order to perform this feedback-control, the current of the particle beam with which the target 60 is irradiated is measured. That is, as illustrated in FIG. 21, the RI manufacturing apparatus 1 includes a current detector 71 that detects the current of the particle beam with which the target 60 is irradiated.

The current detector 71 includes a detector body portion 73 and a detection line 75, and the detector body portion 73 and the target 60 are connected to each other by the detection line 75. For example, a terminal on one end side of the detection line 75 is connected to an end surface on a side far from the derivation portion 104 of the target 60. A current signal indicating a current value of the particle beam with which the target 60 is irradiated is transmitted to the detector body portion 73 through the detection line 75. In this manner, the current detector 71 acquires the current value of the particle beam with which the target 60 is irradiated. Information on the current value acquired here is transmitted to the control unit 77 of the cyclotron 100, and ion generation, current intensity, a charge amount, and the like in the cyclotron 100 are controlled by performing the feedback-control in the control unit 77. The current of the particle beam emitted from the derivation portion 104 of the cyclotron 100 is adjusted.

The current of the particle beam used in irradiating the target 60 is relatively small, for example, such as several tens of μA. Therefore, when the target 60 and the main body part 100a of the cyclotron 100 are not electrically insulated from each other, the current of the particle beam used in irradiating the target 60 is not accurately measured by the current detector 71, and as a result, reliability of the manufacturing amount of the RI cannot be ensured. Therefore, in the RI manufacturing apparatus 1, the target 60 and the cyclotron body part 100a are electrically insulated from each other by an insulation structure (to be described below).

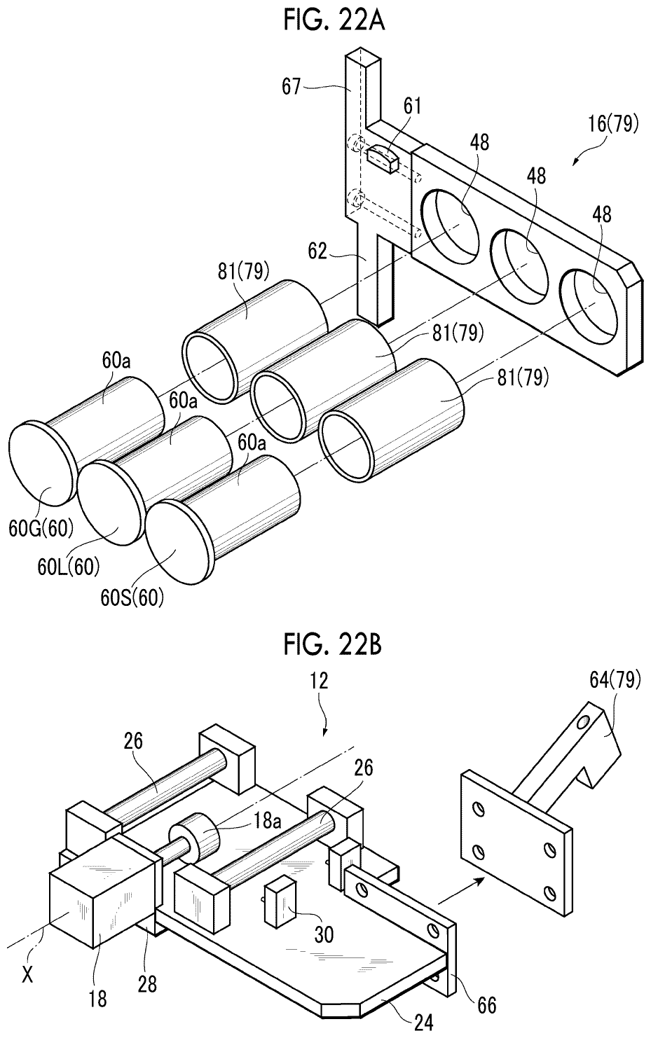

As a specific insulation structure, an electrical insulation member 79 is used. The electrical insulation member 79 is interposed between the target 60 and the cyclotron body part 100a, and at least a portion of the target attachment and detachment device 10 and the attachment base 64 is made of an electrical insulation material. As illustrated in FIGS. 22A and 22B, as a specific example, a cylindrical sleeve 81 is mounted on a column side surface 60a of the target 60, and the target 60 is held by the holding portion 48 of the slide plate 16 via the cylindrical sleeve 81. The cylindrical sleeve 81 is an electrical insulation member 79. In addition, the attachment base 64 is an electrical insulation member 79 made of an electrical insulation material as a whole. In addition, the slide plate 16 is also the electrical insulation member 79 made of the electrical insulation material as a whole.

It is not essential to adopt all of the above-described configuration including the cylindrical sleeve 81 which is the electrical insulation member 79, the above-described configuration in which the attachment base 64 is the electrical insulation member 79, and the configuration in which the slide plate 16 is the electrical insulation member 79, and at least any one of the configurations may be adopted. In addition, two of the above-described configurations may be combined and adopted, and may be appropriately selected depending on various conditions. For example, when a liquid target is used, the target 60 is likely to be thinned. Therefore, the cylindrical sleeve 81 is easily disposed between the target 60 and the holding portion 48, and the cylindrical sleeve 81 can be preferably adopted. For example, when a gas target is used, the target 60 tends to be thickened, and it is difficult to dispose the cylindrical sleeve 81 between the target 60 and the holding portion 48. Therefore, a configuration in which the attachment base 64 is the electrical insulation member 79 or a configuration in which the slide plate 16 is the electrical insulation member 79 is preferably adopted. In addition, using the cylindrical sleeve 81, the attachment base 64, the electrical insulation member 79, and the like as the electrical insulation members as described above is an example, and other portions of the target attachment and detachment device 10 may be the electrical insulation member 79. For example, the adjustment plate 66 may be the electrical insulation member 79.

As a material of the electrical insulation member 79, it is preferable to adopt a material having not only electrical insulation but also radiation resistance to suppress deterioration in the electrical insulation member 79 due to radiation. As the material of the electrical insulation member 79, for example, ceramic, PEEK, polytetrafluoroethylene, or the like can be adopted.

Furthermore, the electrical insulation member 79 may be a member having a radiation shielding function. In this case, an outward leakage of a neutron ray, a gamma ray, or the like generated from the target 60 during the manufacturing of the RI is suppressed. For example, the electrical insulation member 79 may be made of a composite material of a material having electrical insulation and a material having a radiation shielding function. For example, the electrical insulation member 79 may be obtained in such a manner that a member made of a material (for example, heavy metal such as lead or tungsten, aluminum, or polyethylene) having the radiation shielding function is coated with an electrical insulation material (for example, ceramic, PEEK, or polytetrafluoroethylene). In addition, the electrical insulation member 79 may be made of a material which alone has both the electrical insulation function and the radiation shielding function. As an example of the material which alone has the electrical insulation function and the radiation shielding function, for example, metal (for example, heavy metal such as lead or tungsten) having the radiation shielding function may be sintered together with a ceramic material.

According to this insulation structure, the electrical insulation between the target 60 and the cyclotron body part 100a is achieved, and the current is accurately measured by the current detector 71. As a result, the current of the particle beam emitted from the derivation portion 104 of the cyclotron 100 is accurately feedback-controlled, and a desired manufacturing amount of the RI can be obtained with high reliability. Furthermore, when the electrical insulation member 79 also has the radiation shielding function, the radiation emitted to the periphery from the target 60 is reduced through shielding by the electrical insulation member 79. Therefore, it is possible to reduce an exposure to a worker.

### Posture Change Mechanism of Target

In addition, as will be described below, the RI manufacturing apparatus 1 may be provided with a posture change mechanism (incident angle adjustment mechanism) for changing a posture of the target 60 with respect to an irradiation direction of the particle beam. In the following description, an example of the posture change mechanism when the target attachment and detachment device 110 is adopted in the RI manufacturing apparatus 1 will be described. Meanwhile, the same applies even when the target attachment and detachment device 10 is adopted. Therefore, repeated description will be omitted.

In the RI manufacturing apparatus 1, a temperature of the target 60 increases due to the irradiation with the particle beam. When the temperature of the target 60 is excessively high when the target material of the target 60 is a gas, there is a possibility that the target material has an excessively high pressure and the target 60 or the like is damaged. When the temperature of the target 60 is excessively high when the target material of the target 60 is a liquid, there is a possibility that the target material boils and vaporizes to have the excessively high pressure, and the target 60 or the like is damaged. In addition, since the target material boils to form a cavity (air bubble) in the target liquid, efficiency of the nuclear reaction with the particle beam is degraded. When the temperature of the target 60 is excessively high when the target material of the target 60 is a solid, there is a possibility that the target material is melted and oxidized to deteriorate reproducibility of the RI manufacturing, or that the RI is less likely to be recovered due to vaporization of the target material.

Therefore, it is necessary to suppress a heat generation amount per unit area on the target 60 during the particle beam irradiation so that the target 60 does not have the excessively high temperature. In addition, how much the heat generation amount per unit area is allowed depends on a state of the material (gas target, liquid target, or solid target) of each target 60 or physical properties of the target material. Therefore, when the target 60 is replaced by the target attachment and detachment device 110, the heat generation amount needs to be readjusted to a suitable heat generation amount per unit area which corresponds to the target 60. For example, as illustrated in FIGS. 22A and 22B, as an example of usage of the RI manufacturing apparatus 1, in the target attachment and detachment device 110, three types of the targets 60 such as a gas target 60G, a liquid target 60L, and a solid target 60S are set, and the RI is manufactured by sequentially replacing the targets 60G, 60L, and 60S. In this case, it is necessary to change and adjust the heat generation amount per unit area on the target 60 each time the target 60 is replaced.

As a method for adjusting the heat generation amount per unit area on the target 60, it is conceivable to adjust a beam size of the particle beam by adjusting a collimator 83 of the particle beam. As illustrated in FIG. 21, the collimator 83 is provided on an immediately upstream side of the derivation portion 104. However, when the beam size is adjusted by the collimator 83, efficiency is poor since a time is required for the adjustment or there occurs a downtime until the particle beam is stabilized after the adjustment.

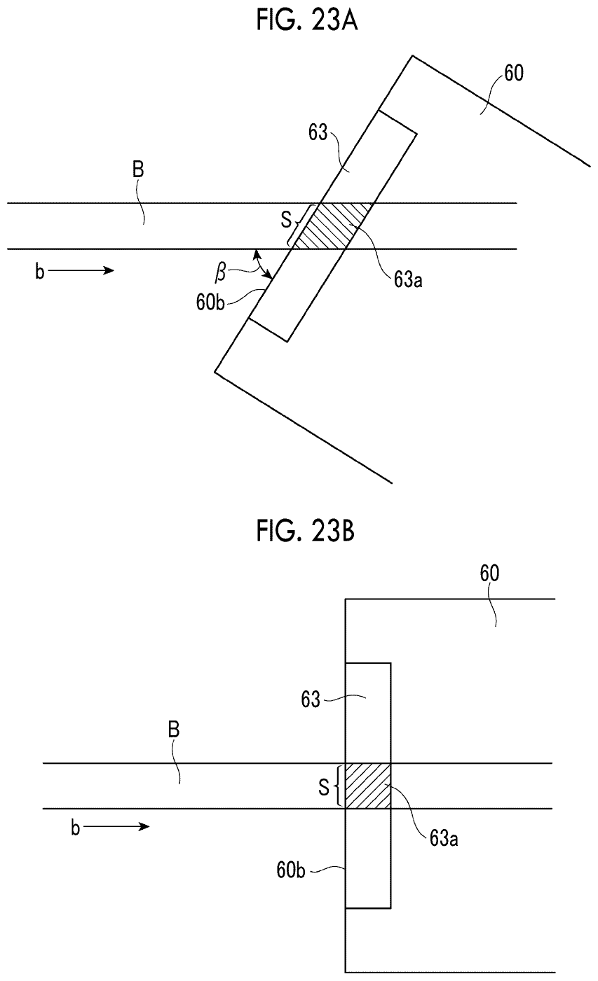

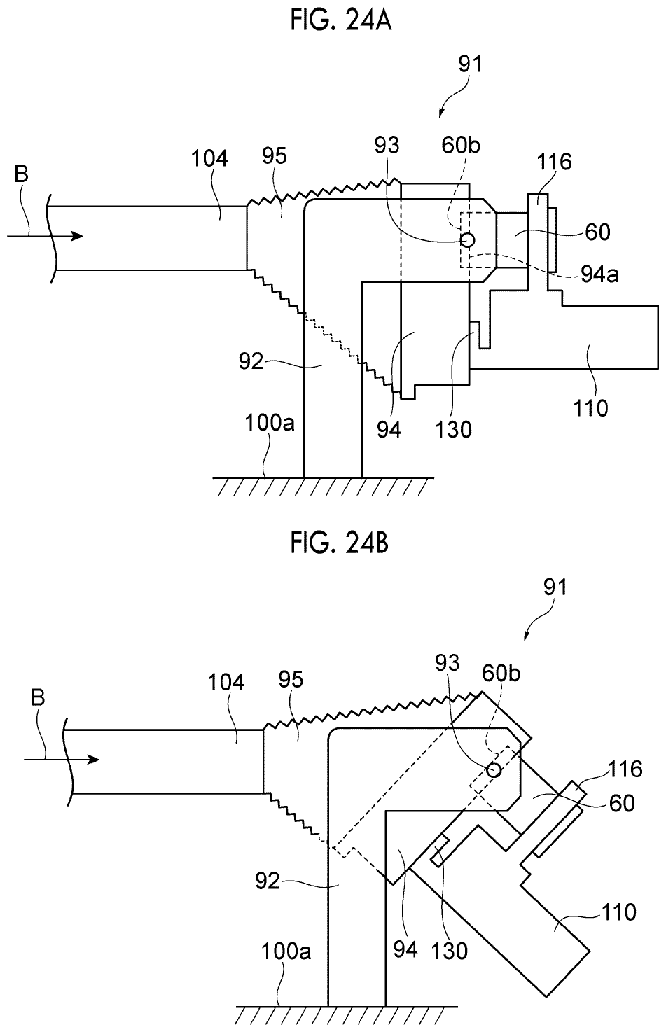

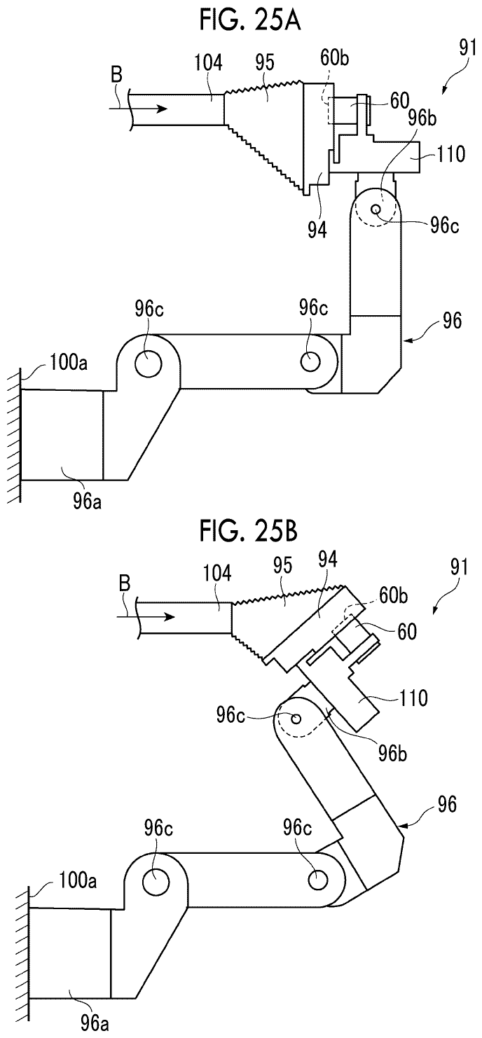

Therefore, the RI manufacturing apparatus 1 is provided with a posture change mechanism 91 (FIGS. 24A to 25B) as means for adjusting the heat generation amount per unit area on the target 60. The posture change mechanism 91 is a mechanism for changing the posture of the target 60 with respect to the irradiation direction of the particle beam. According to the posture change mechanism 91, as schematically illustrated in FIG. 23A, the target 60 can be inclined with respect to the irradiation direction (arrow b) of the particle beam B from the derivation portion 104, and an inclination angle thereof can be adjusted. That is, the posture change mechanism 91 can adjust an incident angle β of a particle beam B with respect to the target 60. FIG. 23A illustrates a state where the particle beam B is incident on a front end surface 60b (surface on a side close to the derivation portion 104) of the target 60 in an inclined direction, and FIG. 23B illustrates a state where the particle beam B is vertically incident on the front end surface 60b of the target 60. In addition, a reference numeral 63 in FIGS. 23A and 23B schematically illustrates the target material disposed along the front end surface 60b of the target 60.

As illustrated in FIG. 23A, in a state where the target 60 is inclined, an area S in which the target 60 is irradiated with the particle beam B is widened without changing the beam size, compared to a state where the target 60 is not inclined (FIG. 23B). As a result, the heat generation amount per unit area on the target 60 decreases. In this way, the heat generation amount per unit area on the target 60 is adjusted by adjusting an inclination angle of the target 60.

A specific mechanism of the posture change mechanism 91 will be described. As illustrated in FIG. 24A, the posture change mechanism 91 includes an L-shaped column portion 92 fixed to the cyclotron body part 100a, a hinge portion 93 disposed in a tip portion of the column portion 92, and a vacuum chamber 94 supported by the column portion 92 to be pivotable via the hinge portion 93. A target insertion port 94a into which a tip portion of the target 60 is inserted is provided on a back surface of the vacuum chamber 94 when viewed from the derivation portion 104. In addition, a fixing plate 130 of the target attachment and detachment device 110 is fixed to the back surface of the vacuum chamber 94. According to the target attachment and detachment device 110, the plurality of targets 60 held by the target attachment and detachment device 110 can be selectively attached to and detached from the target insertion port 94a. A central portion of the front end surface 60b of the target 60 mounted on the target insertion port 94a is disposed at a position substantially the same as that of the hinge portion 93 when viewed in a pivoting axis direction of the hinge portion 93. A front surface of the vacuum chamber 94 and the derivation portion 104 are connected to each other by a tubular bellows 95 capable of expanding and contracting. In this manner, a trajectory of the particle beam B is partitioned from the outside, and is in a vacuum state. The particle beam B emitted from the derivation portion 104 passes through the inside of the bellows 95 and the inside of the vacuum chamber 94, and is used to irradiate the front end surface 60b of the target 60.

In a state in FIG. 24B, the front end surface 60b of the target 60 is perpendicular to the irradiation direction of the particle beam B. From this state, as illustrated in FIG. 24A, the vacuum chamber 94, the target attachment and detachment device 110, and the target 60 receive a driving force from a drive source such as a motor (not illustrated) and are integrally pivotable around the hinge portion 93 with respect to the column portion 92 with any posture. When the target 60 pivots in this way, the front end surface 60b of the target 60 is inclined with respect to the irradiation direction of the particle beam B on the trajectory of the particle beam B. In addition, in this case, the bellows 95 expands and contracts to follow a change in a positional relationship between the derivation portion 104 and the vacuum chamber 94. Therefore, the trajectory of the particle beam B is maintained in the vacuum. In the RI manufacturing apparatus 1, the posture change mechanism 91 as described above can adjust the posture of the target 60 with respect to the irradiation direction of the particle beam B, and can adjust the incident angle β (FIG. 23A) of the particle beam B to the target 60.

A mechanism that causes the vacuum chamber 94, the target attachment and detachment device 110, and the target 60 to integrally pivot as described above is not limited to the mechanism illustrated in FIGS. 24A and 24B. That is, as this mechanism, various mechanisms can be adopted as long as the target attachment and detachment device 110 is pivotable around the vicinity of the front end surface 60b of the target 60. For example, as illustrated in FIGS. 25A and 25B, the posture change mechanism 91 may include a vertical articulated robot 96. A base portion 96a of the vertical articulated robot 96 is fixed to the cyclotron body part 100a, and the target attachment and detachment device 110 is fixed to an arm tip 96b of the vertical articulated robot 96.

The vertical articulated robot 96 includes a robot arm having a plurality of joint portions 96c including a hinge portion, and a commercially available vertical articulated robot may be adopted as the vertical articulated robot 96. The vertical articulated robot 96 can more freely move the target attachment and detachment device 110 than the mechanism illustrated in FIGS. 24A and 24B. Therefore, as a matter of course, the target attachment and detachment device 110 can be moved as in the mechanism illustrated in FIGS. 24A and 24B. The target attachment and detachment device 110 can adjust the posture of the target 60 with respect to the irradiation direction of the particle beam B, and can adjust the incident angle β (FIG. 23A) of the particle beam B to the target 60. FIG. 25A illustrates a state where the front end surface 60b of the target 60 is perpendicular to the irradiation direction of the particle beam B, and FIG. 25B illustrates a state where the front end surface 60b of the target 60 is inclined with respect to the irradiation direction of the particle beam B. In the mechanism of FIGS. 25A and 25B, the same reference numerals will be assigned to the same or equivalent elements as those of the mechanism of FIGS. 24A and 24B, and repeated description will be omitted.

According to the posture change mechanism 91 described above, when the target 60 is replaced with a new one, the posture of the target attachment and detachment device 110 with respect to the cyclotron body part 100a is adjusted in accordance with a state of the material of the target 60 (whether the target 60 is the gas target, the liquid target, or the solid target) or physical properties of the target material. In this manner, the inclination angle of the target 60 with respect to the irradiation direction of the particle beam can be adjusted. In this manner, the heat generation amount per unit area on the target 60 can be suitably adjusted in accordance with the state of the material of the target 60 or the physical properties of the target material.

According to this adjustment, the downtime occurring due to the replacement of the target 60 (60G, 60L, 60S) as described above is reduced, compared to a method for adjusting the beam size of the particle beam B, and as a result, the manufacturing amount of the RI can be increased. In addition, not only when the target 60 is replaced by the target attachment and detachment device 110, but also when the new target 60 is attached to the derivation portion 104, the downtime can be reduced, compared to when the beam size is adjusted, and as a result, the manufacturing amount of RI can be increased.

In addition, even when the states of the material or the properties of the material are different, each target 60 can be irradiated with a suitable particle beam. Therefore, a process for replacing the target 60 is simplified. Therefore, in the target attachment and detachment device 110, for example, the target used for R&D can be handled together with the target used for the RI manufacturing, and as a result, the R&D can be promoted.

In addition, in a state where the target 60 is inclined (FIG. 23A), the number of portions 63a irradiated with the particle beam B in the target material 63 of the target 60 increases compared to a state where the target 60 is not inclined (FIG. 23B). Therefore, the manufacturing amount of the RI increases. For example, in a case of the solid target 60S (FIG. 22A), the target 60 can be inclined with respect to an irradiation direction b, and in a case of the liquid target 60L (FIG. 22A), the target 60 can be perpendicular to the irradiation direction b. Since the target 60 is inclined with respect to the irradiation direction b in the solid target 60S, the number of the portions 63a irradiated with the particle beam B in the target material 63 increases as described above. Therefore, the manufacturing amount of the RI increases. For example, in a case of the liquid target 60L, when the liquid amount of the target material 63 is small, the target 60 is set to be perpendicular to the irradiation direction b. In this manner, the whole target material 63 can be irradiated with the particle beam without increasing the liquid amount of the target material 63.

An inclination direction of the target 60 when the target 60 is inclined is not limited. For example, FIGS. 24A to 25B illustrate an example in which the target attachment and detachment device 110 for holding the target 60 is caused to pivot around the axis parallel to the Y-direction (FIG. 2) so that the target 60 is inclined. However, for example, the target attachment and detachment device 110 may be caused to pivot around the axis perpendicular to both the Y-direction and the X-direction (FIG. 2) so that the target 60 is inclined. Starting from the above-described embodiments, the present invention can be implemented in various forms including various modifications and improvements, based on the knowledge of those skilled in the art. In addition, a modification example can be configured by utilizing technical matters described in the above-described embodiment. Configurations in each embodiment may be used in combination as appropriate.

In the target attachment and detachment devices 10 and 110, since the plurality of targets 60 are arrayed in the Y-direction (FIG. 3) on the slide plate 16 that is displaceable in the Y-direction, the targets 60 can be replaced. However, the present invention is not limited to this configuration. For example, when a direction perpendicular to both the Y-direction and the X-direction (FIG. 2) is defined as a Z-direction, the plurality of targets 60 may be arrayed and held in the Z-direction on the slide plate that is displaceable in the Z-direction. In addition, the plurality of the targets 60 may be two-dimensionally arrayed and held on the slide plate that is two-dimensionally displaceable in a plane perpendicular to the X-direction. In addition, it is not essential that the RI manufacturing apparatus 1 includes a configuration which can hold the plurality of targets 60 as in the target attachment and detachment devices 10 and 110. For example, the targets 60 may be attached to and detached from the derivation portion 104 one by one by another attachment and detachment device or the like.

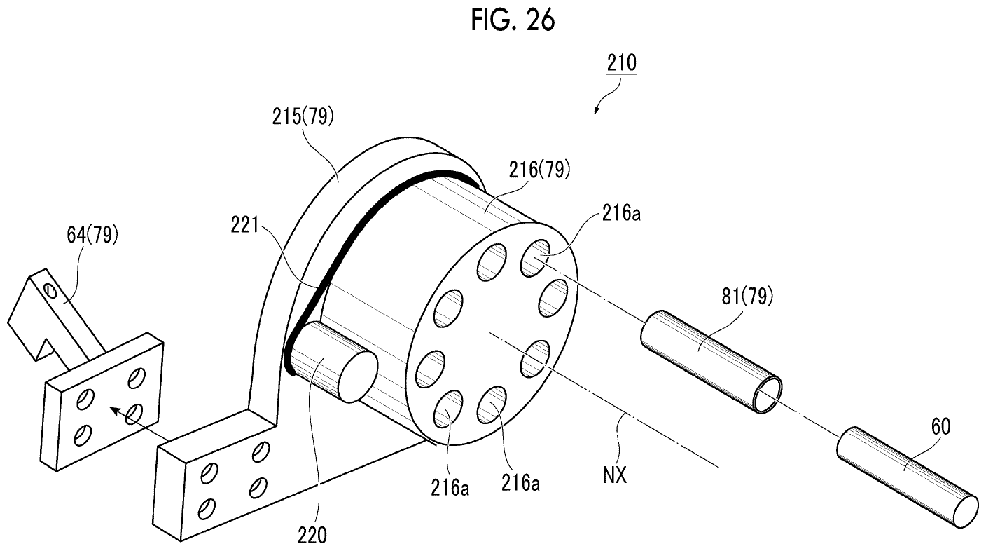

In addition, the target holding member holding the target 60 is not limited to a member moving in translation, and the target holding member may be rotationally moved. For example, a target attachment and detachment device 210 as illustrated in FIG. 26 may be used. The target attachment and detachment device 210 includes a pedestal portion 215 and a columnar rotating body portion 216 (target holding member) rotatably supported by the pedestal portion 215. For example, the pedestal portion 215 is attached to the cyclotron body part 100a via the attachment base 64. The rotating body portion 216 is attached to the pedestal portion 215 in a state where a column axis is directed in the X-direction, and is rotatable around the column axis (rotation axis NX) with respect to the pedestal portion 215. A plurality of circular holes 216a for holding the target 60 are provided around the rotation axis NX in the rotating body portion 216. The circular holes 216a are disposed at an equal interval in a rotation circumferential direction of the rotating body portion 216, and the columnar target 60 is held in each of the circular holes 216a in a state where the column axis is directed in the X-direction.

A motor 220 (third drive unit) is installed on the pedestal portion 215. A driving force of the motor 220 is transmitted to the rotating body portion 216 by a rotary shaft of the motor 220 and a drive belt 221 laid over the rotating body portion 216, and the rotating body portion 216 rotates around the rotation axis NX. Since the rotating body portion 216 rotates in this way, the target 60 facing the derivation portion 104 in the X-direction can be selected, and the selected target 60 is attached to and detached from the derivation portion 104 by a drive unit (not illustrated) that drives the rotating body portion 216 in the X-direction or a drive unit (not illustrated) that drives the pedestal portion 215 in the X-direction. In the target attachment and detachment device 210, at least any one of the cylindrical sleeve 81, the rotating body portion 216, the pedestal portion 215, and the attachment base 64 which are interposed between the target 60 and the circular holes 216a is the electrical insulation member 79. In addition, the target attachment and detachment device 210 may be used instead of the target attachment and detachment device 110 in FIGS. 24A and 24B or FIGS. 25A and 25B.

The accelerator included in the RI manufacturing apparatus 1 is not limited to the cyclotron, and may be another accelerator such as a linear accelerator or a synchrocyclotron.

It should be understood that the invention is not limited to the above-described embodiment, but may be modified into various forms on the basis of the spirit of the invention. Additionally, the modifications are included in the scope of the invention.

What is claimed is:

1. An RI manufacturing apparatus comprising:
an accelerator;
a target irradiated with a particle beam of an accelerated particle emitted from the accelerator; and
an incident angle adjustment mechanism that adjusts an incident angle of the particle beam to the target.

2. The RI manufacturing apparatus according to claim 1, further comprising:
a target attachment and detachment device that is attached to the accelerator, that holds a plurality of the targets, and that selectively attaches and detaches any one of the plurality of targets to and from a derivation portion of the accelerated particle in the accelerator.

3. The RI manufacturing apparatus according to claim 2,
wherein the target attachment and detachment device includes a base plate, a guide plate attached to the base plate and including a guide groove, a slide plate fitted into the guide groove of the guide plate, a first air cylinder attached to a front side surface of the base plate, a second air cylinder provided on an upper surface of the guide plate, and a third air cylinder provided on a lower surface of the guide plate.

4. The RI manufacturing apparatus according to claim 2,
wherein the target attachment and detachment device includes a base plate, a first slide plate and a second slide plate which are mounted on the base plate, a first air cylinder attached to the first slide plate, and a second air cylinder and a third air cylinder which are mounted on an upper surface of the first slide plate.

5. The RI manufacturing apparatus according to claim 4,
wherein a single guide rail extending in a predetermined direction is provided on an upper surface of the base plate.

6. The RI manufacturing apparatus according to claim 2,
wherein the target is attached to and detached from the derivation portion in a state of being held by the target attachment and detachment device, and
the incident angle adjustment mechanism adjusts the incident angle of the particle beam to the target by adjusting a posture of the target attachment and detachment device with respect to the accelerator.

7. The RI manufacturing apparatus according to claim 2,
wherein the target attachment and detachment device holds a plurality of types of the targets having mutually different states of a material.

8. The RI manufacturing apparatus according to claim 2,
wherein the incident angle adjustment mechanism includes a plurality of joint portions for moving the target attachment and detachment device with respect to the accelerator.

9. The RI manufacturing apparatus according to claim 8,
wherein the incident angle adjustment mechanism includes a column portion fixed to the accelerator, a hinge portion disposed in a tip portion of the column portion, and a vacuum chamber supported by the column portion to be pivotable via the hinge portion.
